(19) United States
(12) Patent Application Publication
(10) Pub. No.: US 2008/0210660 A1
(43) Pub. Date: Sep. 4, 2008

(54) Medium For Etching Oxidic, Transparent, Conductive Layers

(75) Inventors: Werner Stockum, Reinheim (DE); Armin Kuebelbeck, Bensheim (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GESELLSCHAFT, Darmstadt (DE)

(21) Appl. No.: 11/994,608

(22) PCT Filed: Jun. 8, 2006
(86) PCT No.: PCT/EP2006/005460

§ 371 Date: Jan. 3, 2008

(30) Foreign Application Priority Data
Jul. 4, 2005 (DE) 10 2005 031 469.4

(51) Int. Cl. H01B 13/00; B44C 1/22; B29D 11/00; C03C 14/00; C03C 25/68; C09K 13/00; C23F 1/10; C23F 1/02

(52) U.S. Cl. 216/13; 216/83; 216/101; 216/25; 252/79.4; 252/79.1; 216/97

(57) ABSTRACT

The present invention relates to a novel dispensable medium for etching doped tin oxide layers having non-Newtonian flow behaviour for etching surfaces in the production of displays and/or solar cells and to the use thereof. In particular, it relates to corresponding particle-free compositions by means of which fine structures can be etched selectively without damaging or attacking adjacent areas.

The present invention relates to a novel dispensable, homogeneous etching medium having non-Newtonian flow behaviour for etching oxidic, transparent, conductive layers and to the use thereof, for example for the production of liquid-crystal displays (LCDs) or organic light-emitting displays (OLEDs).

Specifically, it relates to particle-free compositions by means of which fine structures can be etched selectively in oxidic, transparent and conductive layers without damaging or attacking adjacent areas.

The object of structuring oxidic, transparent, conductive layers on a support material, such as, for example, on thin glass, arises, inter alia, in the production of liquid-crystal displays. An LC display essentially consists of two glass plates provided with oxidic, transparent, conductive layers, usually indium-tin oxide (ITO), with a liquid-crystal layer in between, which change their light transparency through application of a voltage. Contact with the ITO front and back is prevented through the use of spacers. For the display of characters, symbols or other patterns, it is necessary to structure the ITO layer on the glass sheet. This enables areas within the display to be addressed selectively.

### 1. PRIOR ART AND OBJECT OF THE INVENTION

The glass sheets used for display production usually have a singlesided ITO layer thickness in the range from 20 to 200 nm, in most cases in the range from 30 to 130 nm.

During display manufacture, the transparent, conductive layer on the glass sheets is structured in a series of process steps. To this end, use is made of the process of photolithography, which is known to the person skilled in the art.

In the present description, inorganic surfaces are taken to mean oxidic compounds which have increased electrical conductivity due to the addition of a dopant with retention of the optical transparency. The layer systems known to the person skilled in the art are not suitable for this purpose:
indium-tin oxide In₂O₃:Sn (ITO)
fluorine-doped tin oxide SnO₂:F (FTO)
antimony-doped tin oxide SnO₂:Sb (ATO)
aluminium-doped zinc oxide ZnO:Al (AZO)

It is known to the person skilled in the art to deposit indium-tin oxide by cathodic sputtering (in-line sputtering).

ITO layers of adequate conductivity can also be obtained by wet-chemical coating (sol-gel dip process) using a liquid or dissolved solid precursor in a solvent or solvent mixture. These liquid compositions are usually applied to the substrate to be coated by spin coating. These compositions are known to the person skilled in the art as spin-on-glass (SOG) systems.

### Etching of Structures

Use of etchants, i.e. chemically aggressive compounds, causes dissolution of the material exposed to the attack by the etchant. In most cases, the aim is completely to remove the layer to be etched. The end of the etching is achieved by the encountering of a layer which is sub-stantially resistant to the etchant.

Photolithography includes material-intensive and time-consuming and expensive process steps:

In known processes, the following steps are necessary for the production of a negative or positive of the etch structure (depending on the photoresist):
coating of the substrate surface (for example by spin coating with a liquid photoresist),
drying of the photoresist,
exposure of the coated substrate surface,
development,
rinsing
if necessary drying
etching of the structures, for example by
   dip processes (for example wet etching in wet-chemistry benches)
   dipping of the substrates into the etching bath, etching operation
   spin-on or spray processes: the etching solution is applied to a rotating substrate, the etching operation can be carried out without/with input of energy (for example IR or UV irradiation)
   dry-etching processes, such as, for example, plasma etching in complex vacuum units or etching with reactive gases in flow reactors
removal of the photoresist, for example by means of solvent
rinsing
drying

In recent years, structuring with the aid of a LASER beam has established itself as an alternative process to photolithography.

In laser-supported structuring processes, the LASER beam scans the areas to be removed dot by dot or line by line in a vector-oriented system. The transparent, conductive layer spontaneously evaporates at the points scanned with the LASER beam due to the high energy density of the laser beam. The process is quite suitable for the structuring of simple geometries. It is less suitable in the case of more complex structures and especially in the removal of relatively large areas of transparent, conductive layers. The achievable throughput times here are totally inadequate for mass production.

In some applications, such as, for example, the structuring of transparent, conductive layers for OLED displays, LASER structuring is in principle not very suitable: evaporating, transparent, conductive material precipitates on the substrate in the immediate vicinity and increases the layer thickness of the transparent conductive coating in these edge regions. This is a considerable problem for the further process steps, in which an extremely flat surface is required.

An overview of various etching processes is given in
[1] D. J. Monk, D. S. Soane, R. T. Howe, Thin Solid Films 232 (1993), 1;
[2] J. Bühler, F.-P. Steiner, H. Baltes, J. Micromech. Microeng. 7 (1997), R1
[3] M. Köhler “Ätzverfahren für die Mikrotechnik” [Etching Processes for Microtechnology], Wiley VCH 1983.

The disadvantages of the etching processes described are due to the time-consuming, material-intensive and expensive process steps which are in some cases complex in technological and safety terms and are frequently carried out batchwise.

### Objective

The object of the present invention is therefore to provide novel, inexpensive compositions for the selective etching of very uniform, thin lines having a width of less than 500 μm, in particular of less than 100 μm, and of extremely fine structures of doped tin oxide or zinc oxide layers which are used for the production of LC displays. A further object of the present invention is to provide novel etchants and etching media pre-pared therewith which, after etching, can be removed from the treated surfaces in a simple manner without leaving residues using a suitable, environmentally friendly solvent, optionally with exposure to heat.

### 2. DESCRIPTION OF THE INVENTION

Attempts to prepare compositions in the form of pastes which are suitable for achieving the object according to the invention have shown that comparable printing and dispensing properties as with particle-containing pastes can be achieved through the use of selected thickeners. Chemical interactions with the other constituents of the etching medium enable a gelatinous network to be formed. These novel gelatinous pastes exhibit particularly excellent properties for paste application by means of the dispenser technique, enabling non-contact paste application.

The object according to the invention of selectively etching or structuring surfaces of oxidic layers, in particular of tin oxide or zinc oxide layers or corresponding doped layers, such as indium-tin oxide In₂O₃:Sn (ITO), fluorine-doped tin oxide SnO₂:F (FTO), antimony-doped tin oxide SnO₂:Sb (ATO) or aluminium-doped zinc oxide ZnO:AI (AZO), is, surprisingly, achieved through the use of iron(III) chloride or iron(III) chloride hexahydrate as etching component for corresponding oxidic surfaces. In particular, the object according to the invention is therefore achieved by the provision and use of a novel printable etching medium, preferably having non-Newtonian flow behaviour, in the form of an etching paste for etching doped, oxidic, transparent, conductive layers.

A corresponding paste comprises thickeners selected from the group polystyrene, polyacrylate, polyamide, polyimide, polymethacrylate, melamine resin, urethane resin, benzoguanine resin, phenolic resin, silicone resin, fluorinated polymers (PTFE, PVDF, inter alia), and micronised wax, in the presence of at least one etching component, and in the presence of at least one solvent. In addition, the composition according to the invention may comprise inorganic and/or organic acid, and optionally additives, such as antifoams, thixotropic agents, flow-control agents, deaerators, adhesion promoters. Compositions according to the invention are effective at elevated temperatures in the range from 30 to 330° C., preferably in the range from 40 to 200° C. and very particularly preferably 50 to 120° C. or can be activated by input of energy in the form of heat or IR radiation. In particular, the object according to the invention is achieved through the use of iron(III) chloride or iron(III) chloride hexahydrate as selectively etching component in compositions in the form of pastes according to claims 2-7 for etching oxidic surfaces, in particular for etching surfaces which consist of SnO₂ or zinc oxide, or oxidic, transparent, conductive layers which, besides SnO₂ or zinc oxide, optionally comprise one or more doping components, or for etching uniform, homogeneous, non-porous or porous doped tin oxide surfaces, (ITO and/or FTO) systems and layers of variable thickness of such systems. These surfaces are preferably etched using pastes having the properties claimed in claim 8. For the uses claimed, preference is given to the use of compositions according to claims 12-23.

The present application additionally also relates to the use of compositions comprising iron(III) chloride or iron(III) chloride hexahydrate for etching SiO₂— or silicon nitride-containing glasses and above-mentioned oxidic surfaces in special industrial production processes according to claims 9-11.

The pastes according to the invention are preferably used in processes as claimed by claims 24 to 29.

### DETAILED DESCRIPTION OF THE INVENTION

A very wide variety of compositions by means of which thin lines can be etched into inorganic or inorganic oxidic surfaces which are resistant per se are known from patents and the journal literature. However, it was hitherto a problem to etch thin lines selectively into surfaces of tin oxides or zinc oxides since the etching components usually used either had an excessive etching action or are ineffective with respect to these surfaces.

Experiments have now shown that oxidic surfaces can be etched selectively and in a simple manner using a composition comprising iron(III) chloride or iron(III) chloride hexahydrate as etching component. Such compositions are particularly suitable for surfaces which comprise or consist of SnO₂ or zinc oxide. Using these compositions, thin lines and extremely fine structuring can be etched into oxidic, transparent, conductive layers which, besides SnO₂ or zinc oxide, comprise one or more doping components. However, these compositions can also be used extremely well for etching uniform, homogeneous, non-porous or porous doped tin oxide surfaces, (ITO and/or FTO) systems and layers of variable thickness of such systems. Particularly good etching results are achieved if iron(III) chloride or iron(III) chloride hexahydrate is used as described as etching component in a composition for etching oxidic surfaces in the presence of an inorganic mineral acid, where a mineral acid selected from the group hydrochloric acid, phosphoric acid, sulfuric acid and nitric acid is used. Iron(III) chloride or iron(III) chloride hexahydrate can be employed here in the presence of a mineral acid and/or at least one organic acid, which may have a straight-chain or branched alkyl radical having 1-10 C atoms, selected from the group of the alkylcarboxylic acids, the hydroxycarboxylic acids or the dicarboxylic acids. Particularly suitable for this purpose are organic acids selected from the group formic acid, acetic acid, lactic acid and oxalic acid.

In order to be able to print thin lines having a width of a few microns or thinner, it is advisable to use corresponding compositions in the form of a paste which comprise homogeneously dispersed thickening agents in an amount of 0.5 to 25% by weight, based on the total amount.

Thickening agents which may be present are one or more homogeneously dissolved thickening agents from the group

cellulose/cellulose derivatives and/or
starch/starch derivatives and/or
xanthan and/or
polyvinylpyrrolidone,
polymers based on acrylates or functionalised vinyl units.

Corresponding pastes which has a viscosity at 20° C. in a range from 6 to 35 Pa*s at a shear rate of up to 25 s⁻¹, preferably have a viscosity in the range from 10 to 25 Pa*s and very particularly in the range from 15 to 20 Pa*s, have advantageous properties for the use according to the invention. Such etching pastes are highly suitable for etching SiO₂— or silicon nitride-containing glasses which are in the form of uniform, homogeneous, non-porous and porous solids

or
for etching corresponding non-porous and porous glass layers of variable thickness which have been formed on other substrates.

The paste-form compositions can also readily be employed for opening layers of doped tin oxide surfaces (ITO and/or FTO) in the process for the production of semiconductor components and integrated circuits thereof or of components for high-performance electronics and give very accurate etching results. Particular possible applications of the compositions comprising iron(III) chloride or iron(III) chloride hexahydrate in the form of pastes are in display technology (TFTs), in photovoltaics, semiconductor technology, high-performance electronics, mineralogy or the glass industry, in the production of OLED lighting, of OLED displays, and in the production of photodiodes and for the structuring of ITO glasses for flat-panel screen applications (plasma displays).

In accordance with the invention, the compositions for etching oxidic layers comprise
a) iron(III) chloride or iron(III) chloride hexahydrate as etching component
b) solvent
c) optionally a homogeneously dissolved organic thickening agent
d) optionally at least one inorganic and/or organic acid, and optionally
e) additives, such as antifoams, thixotropic agents, flow-control agents, deaerators, adhesion promoters, and
   are in the form of pastes which are printable and can be applied to the surfaces to be etched in extremely thin lines or finely structured by suitable printing techniques.

These compositions may comprise the etching component in an amount of 1 to 30% by weight and the thickening agent in an amount of 3 to 20% by weight, based on the total amount. The etching component is preferably present in an amount of 2 to 20% by weight, particularly preferably in an amount of 5 to 15% by weight, based on the total amount.

As already indicated above, it is advantageous for the compositions, in addition to iron(III) chloride or iron(III) chloride hexahydrate, to comprise, as etching component, an inorganic mineral acid selected from the group hydrochloric acid, phosphoric acid, sulfuric acid, nitric acid and/or at least one organic acid, which may have a straight-chain or branched alkyl radical having 1-10 C atoms, selected from the group of the alkylcarboxylic acids, the hydroxycarboxylic acids or the dicarboxylic acid solutions, since the etching operation can thus be matched to the requirements of the respective layers to be etched. Particularly suitable organic acids for the preparation of the pastes according to the invention are formic acid, acetic acid, lactic acid and oxalic acid.

In total, the proportion of the organic and/or inorganic acid(s) in compositions according to the invention can be in a concentration range from 0 to 80% by weight, based on the total amount of the medium, where the added acid or mixtures thereof each have a pKₐ value of between 0 to 5.

The compositions according to the invention may comprise, as solvent, water, mono- or polyhydric alcohols selected from the group glycerol, 1,2-propanediol, 1,4-butanediol, 1,3-butanediol, 1,5-pentanediol, 2-ethyl-1-hexenol, ethylene glycol, diethylene glycol and dipropylene glycol, ethers selected from the group ethylene glycol monobutyl ether, triethylene glycol monomethyl ether, diethylene glycol monobutyl ether and dipropylene glycol monomethyl ether, esters selected from the group [2,2-butoxy(ethoxy)]ethyl acetate, propylene carbonate, ketones, such as acetophenone, methyl-2-hexanone, 2-octanone, 4-hydroxy-4-methyl-2-pentanone and 1-methyl-2-pyrrolidone, as such or in a mixture, in an amount of 10 to 90% by weight, preferably in an amount of 15 to 85% by weight, based on the total amount of the medium. In order to achieve the pasty, thixotropic properties, one or more homogeneously dissolved thickening agents from the group

cellulose/cellulose derivatives and/or
starch/starch derivatives and/or
xanthan and/or
polyvinylpyrrolidone
polymers based on acrylates or functionalised vinyl units
may be present in an amount of 0.5 to 25% by weight, based on the total amount of the etching medium. In order to improve the use properties of the compositions, additives selected from the group antifoams, thixotropic agents, flow-control agents, deaerators and adhesion promoters may additionally be added in an amount of 0 to 5% by weight, based on the total amount.

Compositions in which the individual components have been combined with one another in an optimal manner and mixed with one another in a suitable manner have, as already described above, a viscosity at a temperature of 20° C. in a range from 6 to 35 Pa*s and at the same 10 time a shear rate of up to 25 s⁻¹, preferably a viscosity in the range from to 25 Pa*s at a shear rate of 25 s⁻¹ and very particularly preferably 15 to 20 Pa*s at a shear rate of 25 s⁻¹.

In accordance with the invention, the novel compositions in the form of etching pastes having thixotropic, non-Newtonian properties are used to structure oxidic, transparent, conductive layers in a suitable manner during the process for the production of products for OLED displays, LC displays or for photovoltaics, semiconductor technology, high-performance electronics, of solar cells or photodiodes.

To this end, the paste is applied or printed in a single process step over the entire surface to be etched or in accordance with the etch structure mask selectively only to the areas on the surface where etching is desired and, when the etching is complete, is removed again after a pre-specified exposure time by rinsing off using a solvent or solvent mixture, or the etching paste is burnt off by heating. After removal by heating, the treated surface can be rinsed again if necessary for cleaning and removal of any residues of the etching paste that may still be adhering.

In this way, it is possible to etch and structure the surface in the printed areas, while non-printed areas are retained in the original state. In order to carry out the actual etching, the etching paste composition is applied to the surface to be etched and removed again after an exposure time 35 of 10 s-15 min, preferably after 30 s to 2 min. This procedure is particularly suitable for the treatment of inorganic, glass-like, crystalline surfaces, as have to be formed and treated in processes in the semiconductor industry.

The surface to be etched here can be a surface or part-surface of oxidic, transparent, conductive material and/or a surface or part-surface of a porous and non-porous layer of oxidic, transparent, conductive material on a support material.

In the process according to the invention, the etching of the surfaces to be treated is usually carried out at elevated temperatures in the range from 30 to 330° C., preferably in the range from 40 to 200° C. and very particularly preferably 50 to 120° C.

In this connection, optimisation experiments have shown that doped tin oxide surfaces (ITO and/or FTO) can be etched with etching rates of 0.5 to 8 nm/s at elevated temperatures in the range from 50 to 120° C. Under particularly suitable conditions, the etching is carried out with etching rates of 1 to 6 nm/s, in particular with etching rates of 3 to 4 nm/s.

For the transfer of the etching paste to the substrate surface to be etched, a suitable printing process with a high degree of automation and throughput is used. In particular, suitable printing processes for this purpose which are known to the person skilled in the art are the dispenser technique, screen, stencil, pad, stamp, ink-jet printing processes. However, manual application is likewise possible.

Depending on the dispenser technique, screen, stencil, klischee, stamp design or cartridge control, it is possible to apply the printable, homogeneous, particle-free etching pastes having non-Newtonian flow behaviour which are described in accordance with the invention over the entire area or in accordance with the etch structure mask selectively only to the areas where etching is desired. All masking and lithography steps which are otherwise necessary are thus superfluous. The etching operation can take place with or without input of energy, for example in the form of heat radiation (using IR lamps).

The actual etching process is subsequently completed as already described by washing the surfaces with water and/or a suitable solvent or solvent mixture. When the etching is complete, the residues of the originally printable etching pastes having non-Newtonian flow behaviour are rinsed off the etched surfaces using a suitable solvent or solvent mixture. The treated surfaces are dried in a known manner.

For environmental reasons, inter alia, the rinsing is preferably carried out using water; only if necessary and advantageous for technical and qualitative reasons are solvents optionally added to the water or other solvents used alone or as a mixture. For this rinsing operation, solvents as have already been used for the preparation of the compositions can be added to the water. Corresponding solvents have already been mentioned above. In addition, further solvents which are generally known to the person skilled in the art for this purpose from semiconductor technology can be used. Solvents having suitable physical properties can be employed individually or as a mixture. Preference is given here to the use of solvents which have a good dissolution capacity for the paste residues on the surfaces, have a suitable vapour pressure, enabling easy drying after the rinsing of the surfaces, and at the same time have environmentally friendly properties.

Use of the etching pastes according to the invention thus enables etching to be carried out inexpensively in mass production on an industrial scale in a suitable automated process.

In a preferred embodiment, the etching paste according to the invention has a viscosity in the range from 5 to 100 Pa·s, preferably from 10 to 50 Pa·s. The viscosity here is the material-dependent component of the frictional resistance which counters the movement during sliding of adjacent liquid layers. According to Newton, the shear resistance in a liquid layer between two sliding surfaces arranged parallel and moved relative to one another is proportional to the velocity or shear gradient G. The proportionality factor is a material constant which is known as dynamic viscosity and has the dimension m Pa·s. In the case of Newtonian liquids, the proportionality factor is pressure- and temperaturedependent. The degree of dependence here is determined by the material composition. Liquids or substances of inhomogeneous composition have non-Newtonian properties. The viscosity of these materials is additionally dependent on the shear gradient.

The more pronounced pseudoplastic or thixotropic properties of the etching paste compositions have a particularly advantageous effect in screen or stencil printing and result in considerably improved results. In particular, this is evident in a shortened etching time or in an increased etching rate with the same etching time and especially in a greater etching depth in the case of thicker layers.

It has been found that iron(III) chloride, iron(III) chloride hexahydrate, and/or hydrochloric acid solutions are capable of completely etching away doped tin oxide surfaces (ITO) having a layer thickness of 200 nm within a few seconds to minutes at temperatures above 50° C. At 100° C., the etching time is about 60 seconds.

For the preparation of the particle-free media according to the invention, the solvents, etching components, thickening agents and additives are mixed successively with one another and stirred for a sufficient time until a viscous paste having thixotropic properties has formed. The stirring can be carried out with warming to a suitable temperature. The components are usually stirred with one another at room temperature.

Preferred uses of the printable etching pastes according to the invention arise for the processes described for structuring ITO applied to a support material (glass or silicon layer), for the production of OLED displays, TFT displays or thin-layer solar cells.

As already mentioned, the pastes can be applied by means of the dispenser technique. Here, the paste is transferred into a plastic cartridge. A dispenser needle is screwed onto the cartridge. The cartridge is connected to the dispenser control via a compressed-air hose. The paste can then be forced through the dispenser needle by means of compressed air. The paste here can be applied as a fine line to a substrate for example an ITO-coated glass). Depending on the choice of the internal diameter of the needle, paste lines of various width can be produced.

A further possibility for paste application is screen printing.

For application of the pastes to the surfaces to be treated, the etching pastes can be forced through a fine-mesh screen which contains the print stencil (or etched metal screens). In a further step, burning-in of the pastes can be carried out in the screen printing process by the thick-layer technique (screen printing of conductive metal pastes), enabling the electrical and mechanical properties to be determined. Instead, the burning-in (firing through the dielectric layers) can also be omitted on use of the etching pastes according to the invention, and the applied etching pastes can be washed off after a certain exposure time using a suitable solvent or solvent mixture. The etching operation is terminated by the washing.

In order to carry out the etching, an etching paste as described, for example, in Example 1 is prepared. Using an etching paste of this type, a layer of doped tin oxide (ITO) having a thickness of about 120 nm can be removed selectively within 60 seconds at 120° C. by the screen printing process. The etching is subsequently completed by dipping the Si wafer into water, followed by rinsing with the aid of a water jet in the form of a fine spray.

The complete disclosure content of all applications, patents and publications mentioned above and below, and the corresponding application DE 10 2005 031 469.4, filed on Apr. 7, 2005, are incorporated into this application by way of reference.

### 4. EXAMPLES

For better understanding and in order to illustrate the invention, examples are given below which are within the scope of protection of the present invention. These examples also serve to illustrate possible variants. Owing to the general validity of the inventive principle described, however, the examples are not suitable for reducing the scope of protection of the present application to these alone.

The temperatures given in the examples are always in ° C. It furthermore goes without saying that, both in the description and in the examples, the added amounts of the components always add up to a total of 100% in the compositions.

### Example 1

Etching paste consisting of homogeneous thickening agent

20 g of iron(III) chloride
is added with stirring to a solvent mixture consisting of
60 g of water
20 g of hydrochloric acid.

4 g of Finnfix 700 (carboxymethylcellulose sodium salt)

are then added slowly in portions to the solution with vigorous stirring, and the mixture is stirred for a further 30 minutes. The clear paste is then transferred into a dispenser cartridge.

The paste, which is now ready to use, can then be applied to ITO surfaces by means of the dispenser.

### Example 2

Etching paste consisting of homogeneous thickening agent

20 g of iron(III) chloride
is added with stirring to a solvent mixture consisting of
30 g of water
10 g of ethylene glycol
20 g of water
20 g of hydrochloric acid.

4 g of Finnfix 2000

are then added slowly in portions to the solution with vigorous stirring, and the mixture is stirred for a further 30 minutes. The clear paste is then transferred into a dispenser cartridge.

The paste, which is now ready to use, can then be applied to ITO surfaces by means of the dispenser.

### Example 3

Etching paste consisting of homogeneous thickening agent

20 g of iron(III) chloride
is added with stirring to a solvent mixture consisting of
15 g of water
15 g of lactic acid
10 g of ethylene glycol
20 g of water
20 g of hydrochloric acid.

4 g of Finnfix 2000

are then added slowly in portions to the solution with vigorous stirring, and the mixture is stirred for a further 30 minutes. The clear paste is then transferred into a dispenser cartridge.

The paste, which is now ready to use, can then be applied to ITO surfaces by means of the dispenser.

### Application Example

For paste application by dispensing and etching, the following parameters are used:

Application rate XY stage (JR 2204): 100 mm/s
Dispenser (EFD 1500XL)—working pressure: 2-3 bar
Dispensing needle internal diameter: 230-260 μm
Etching parameters: 120° C. for 1 min (hotplate)
Rinsing: 30 sec in ultrasound bath
Drying: using compressed air
Result of an Etched ITO layer Having a Thickness of 125 nm on Glass:

Etched line widths from 450 to 550 μm.

1. A method of iron(III) chloride or iron(III) chloride hexahydrate as etching for etching oxidic surfaces comprising applying component in an etching composition.

2. Method according to claim 1 for etching oxidic surfaces which comprise or consist of SnO₂ or zinc oxide.

3. Method according to claim 1 as for etching oxidic, transparent, conductive layers which, besides SnO₂ or zinc oxide, one or more doping components,
or for etching uniform, homogeneous, non-porous or porous doped tin oxide surfaces, (ITO and/or FTO) systems and layers of variable thickness of such systems.

4. Method according to claim 1 for etching oxidic surfaces in the presence of an inorganic mineral acid selected from the group hydrochloric acid, phosphoric acid, sulfuric acid, nitric acid and/or at least one organic acid, which may have a straight-chain or branched alkyl radical having 1-10 C atoms, selected from the group of the alkylcarboxylic acids, the hydroxycarboxylic acids or the dicarboxylic acids.

5. Method according to claim 4, in the presence of an organic acid selected from the group formic acid, acetic acid, lactic acid and oxalic acid.

6. Method according to claim 1 wherein said composition in the form of a paste which comprises a homogeneously dispersed thickening agent in amounts 0.5 to 25% by weight, based on the total amount.

7. Method according to claim 6 wherein said composition in the form of a paste which comprises one or more homogeneously dissolved thickening agents from the group
cellulose/cellulose derivatives and/or
starch/starch derivatives and/or
xanthan and/or
polyvinylpyrrolidone,
polymers based on acrylates or functionalised vinyl units.

8. Method according to claim 1 wherein said composition in the form of a paste which has a viscosity at 20° C. in a range from 6 to 35 Pa*s and a shear rate of up to 25 s⁻¹, preferably a viscosity in the range from 10 to 25 Pa*s and very particularly in the range from 15 to 20 Pa*s.

9. Method according to claim 1 wherein said composition in the form of a paste for etching SiO₂- or silicon nitride-containing glasses which are in the form of uniform, homogeneous, non-porous and porous solids
or
for etching corresponding non-porous and porous glass layers of variable thickness which have been formed on other substrates.

10. Method according to claim 1 wherein said composition in the form of a paste for opening layers of doped tin oxide surfaces (ITO and/or FTO) in the process for the production of semiconductor components and integrated circuits thereof or of components for high-performance electronics

11. Method according to claim 1 wherein said composition in the form of a paste in display technology (TFTs), in photovoltaics, semiconductor technology, high-performance electronics, mineralogy or the glass industry, in the production of OLED lighting, of OLED displays, and for the production of photodiodes and for the structuring of ITO glasses for flat-panel screen applications (plasma displays).

12. Composition for etching oxidic layers, comprising
a) iron(III) chloride or iron(III) chloride hexahydrate as etching component
b) solvent
c) optionally a homogeneously dissolved organic thickening agent
d) optionally at least one inorganic and/or organic acid, and optionally
e) additives, such as antifoams, thixotropic agents, flow-control agents, deaerators, adhesion promoters, and
which is in the form of a paste and is printable.

13. Composition according to claim 12, characterised in that it comprises the etching component in an amount of 1 to 30% by weight and the thickening agent in an amount of 3 to 20% by weight, based on the total amount.

14. Composition according to claim 12, characterised in that it comprises the etching component in an amount of 2 to 20% by weight, based on the total amount.

15. Composition according to claim 12, characterised in that it comprises the etching component in an amount of 5 to 15% by weight, based on the total amount.

16. Composition according to claim 12, characterised in that it comprises an inorganic mineral acid selected from the group hydrochloric acid, phosphoric acid, sulfuric acid, nitric acid and/or at least one organic acid, which may have a straight-chain or branched alkyl radical having 1-10 C atoms, selected from the group of the alkylcarboxylic acids, the hydroxycarboxylic acids or the dicarboxylic acid solutions.

17. Composition according to claim 16, characterised in that it comprises an organic acid selected from the group formic acid, acetic acid, lactic acid and oxalic acid.

18. Composition according to claim 12, characterised in that the proportion of the organic and/or inorganic acids is in a concentration range from 0 to 80% by weight, based on the total amount of the medium, where the added acid or mixtures thereof each have a pKₐ value of between 0 to 5.

19. Composition according to claim 12, characterised in that it comprises, as solvent, water, mono- or polyhydric alcohols selected from the group glycerol, 1,2-propanediol, 1,4-butanediol, 1,3-butanediol, 1,5-pentanediol, 2-ethyl-1-hexenol, ethylene glycol, diethylene glycol and dipropylene glycol, ethers selected from the group ethylene glycol monobutyl ether, triethylene glycol monomethyl ether, diethylene glycol monobutyl ether and dipropylene glycol monomethyl ether, esters selected from the group [2,2-butoxy(ethoxy)]ethyl acetate, propylene carbonate, ketones, such as acetophenone, methyl-2-hexanone, 2-octanone, 4-hydroxy-4-methyl-2-pentanone and 1-methyl-2-pyrrolidone, as such or in a mixture in an amount of 10 to 90% by weight, preferably in an amount of 15 to 85% by weight, based on the total amount of the medium.

20. Composition according to claim 12, characterised in that it comprises one or more homogeneously dissolved thickening agents from the group
cellulose/cellulose derivatives and/or
starch/starch derivatives and/or
xanthan and/or
polyvinylpyrrolidone
polymers based on acrylates or functionalised vinyl units.

21. Composition according to claim 20, characterised in that it comprises a homogeneously dispersed thickener in amounts 0.5 to 25% by weight, based on the total amount of the etching medium.

22. Composition according to claim 12, characterised in that it comprises additives selected from the group antifoams, thixotropic agents, flow-control agents, deaerators and adhesion promoters in an amount of 0 to 5% by weight, based on the total amount.

23. Composition according to claim 12, characterised in that it has a viscosity at a temperature of 20° C. in a range from 6 to 35 Pa*s at a shear rate of 25 s⁻¹, preferably in the range from 10 to 25 Pa*s at a shear rate of 25 s⁻¹ and very particularly preferably 15 to 20 Pa*s at a shear rate of 25 s⁻¹.

24. Process for etching inorganic, glass-like, crystalline surfaces, characterised in that a composition according to claim 12 is applied over the entire area or in accordance with the etch structure mask selectively only to the areas on the surface where etching is desired and in that, when the etching is complete, is rinsed off using a solvent or solvent mixture or burnt off by heating.

25. Process according to claim 24, characterised in that said composition is applied to the surface to be etched and removed again after an exposure time of 10 s-15 min, preferably after 30 s to 2 min.

26. Process according to claim 24, characterised in that said composition according to one or more of claims 12 to 23 is applied by means of dispensers, or by a screen, stencil, pad, stamp, ink-jet, manual printing process.

27. Process according to claim 24, characterised in that the etching composition is rinsed off using water when the etching is complete.

28. Process according to claim 24, characterised in that the etching is carried out at elevated temperatures in the range from 30 to 330° C., preferably in the range from 40 to 200° C. and very particularly preferably 50 to 120° C.

29. Process according to claim 24, characterised in that doped tin oxide surfaces (ITO and/or FTO) are etched with etching rates of 0.5 to 8 nm/s, preferably with etching rates of 1 to 6 nm/s and very particularly preferably with etching rates of 3 to 4 nm/s at elevated temperature in the range from 50 to 120° C.
